(19) United States
(12) Patent Application Publication
(10) Pub. No.: US 2003/0135608 A1
(43) Pub. Date: Jul. 17, 2003

(54) Dynamic media interleaving

(75) Inventors: William Kress Bodin, Austin, TX (US); Derral Charles Thorson, Austin, TX (US)

Correspondence Address: BIGGERS & OHANIAN, PLLC, 5 SCARLET RIDGE, AUSTIN, TX, 78737, US

(73) Assignee: INTERNATIONAL BUSINESS MACHINES CORPORATION, ARMONK, NY

(21) Appl. No.: 10/047,023

(22) Filed: Jan. 15, 2002

(51) Int. Cl. H04N 7/025; H04N 7/10; G06F 15/16; G06F 15/173

(52) U.S. Cl. 709/224; 709/219

(57) ABSTRACT

Methods and systems for providing preferred location specific content for interleaving into broadcast content including storing user preferences in user preference records, storing location specific content (LSC) in LSC records, and receiving, from the digital communications network, a location of the user client device. Embodiments typically include determining local date and time at the location of the user client device, creating preferred location specific content (PISC) records in dependence upon the LSC records, the user preferences, the location of the user client device, and the local date and time at the location of the client device, and downloading the PLSC records through the digital communications network to the user client device.

### BACKGROUND OF THE INVENTION

1. Field of the Invention

The field of the invention is data processing, or, more specifically, methods, systems, and products for dynamic media interleaving.

2. Description of Related Art

Radio broadcasts include program content as well as news, sports, weather, stock quotes, local interest items, public service announcements, advertising, and so on. None of the non-program content is location specific, nor is it organized according to the preferences of individual listeners. It would be advantageous, however, if such content could be organized, interleaved into preexisting program content, and presented to listeners in accordance with the listeners' present physical location as well as the listeners' person preferences.

### SUMMARY

Typical embodiments of the invention include a method of providing preferred location specific content for interleaving into broadcast content, the method implemented upon a content server. Exemplary embodiments typically include a content server including at least one computer processor and computer memory, where the processor is coupled to the computer memory, and a content server coupled for data communications through a digital communications network to a user client device. Other embodiments typically include a user client device associated in the content server with a particular user, and a particular user represented in the content server by a user account record. In typical embodiments, the user account record includes data elements comprising a user identification identifying the user, and a network address for the user's user client device within the digital communications network. Exemplary embodiments typically include a user client device associated in the content server with an address in the digital communications network, the digital communications network having the capability of providing the present location of the user client device.

Exemplary embodiments of the invention typically include storing user preferences in user preference records, storing location specific content (LSC) in LSC records, and receiving, from the digital communications network, a location of the user client device. Other embodiments typically include determining local date and time at the location of the user client device, creating preferred location specific content (PLSC) records in dependence upon the LSC records, the user preferences, the location of the user client device, and the local date and time at the location of the client device, and downloading the PLSC records through the digital communications network to the user client device.

In exemplary embodiments of the invention, storing LSC typically includes receiving user preferences entered by a user through a browser and data mining LSC from vendors' customer databases. In other embodiments, user preference records typically include data elements comprising priority and user preferences. In exemplary embodiments, LSC records typically include data elements comprising digital content, content type, target location, duration, relevant date range, and relevant time range.

In exemplary embodiments of the invention, PLSC records include data elements comprising digital content, duration, and user identification. In some exemplary embodiments creating PLSC records typically include selecting LSC records in dependence upon the user preferences, the location of the user client device, and the local date and time at the location of the client device. In other exemplary embodiments creating PLSC records typically includes selecting LSC records having content types, target locations, and relevant date and time ranges that match, for a user, the user preferences from a user preference record for the user, the location of the user client device associated with the user, and the local date and time at the location of the user client device associated with the user.

In exemplary embodiments of the invention, downloading the PLSC records to the user client device typically includes downloading the PLSC to the user client device at the network address for the user client device within the digital communications network, where the PLSC so downloaded includes digital content and duration. In some exemplary embodiments, the PLSC records to be downloaded include priority, and downloading the PLSC to the user client device. In exemplary embodiments, downloading the PLSC to the user client device includes downloading the PLSC to the user client device in dependence upon priority, and excluding priority from the downloaded PLSC records. In other exemplary embodiments, downloading the PLSC to the user client device typically includes downloading the PLSC to the user client device at the address with which the user client device is associated in the digital communications network, wherein the PLSC so downloaded comprises digital content, duration, and priority.

Exemplary embodiments of the invention typically include storing more than one indication of the location of the user client device and, associated with each such indication of location of the user client device, the local time when the user client device was at the location, and calculating, in dependence upon the stored indications of location and time, a speed of the user client device and a direction of travel of the user client device. In typical embodiments, creating preferred location specific content (PLSC) records in dependence upon the user preferences, the location of the user client device, and the local date and time at the location of the client device includes creating preferred location specific content (PLSC) records in dependence upon the user preferences, the location of the user client device, the local date and time at the location of the client device, and the speed and direction of travel of the user client device. Some embodiments include periodically repeating the steps of receiving a location, determining local date and time, creating PLSC records, and downloading the PLSC records to the user client device. Other embodiments include calculating, for the step of periodically repeating, a repetition rate, wherein the calculating is carried out in dependence upon the speed of the user client device.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a block diagram of an exemplary embodiment of a system for interleaving location specific content.

FIG. 2 is a control flow diagram of an exemplary embodiment of a system for interleaving location specific content.

FIG. 3 is a control flow diagram of a further exemplary embodiment of a system for interleaving location specific content.

FIG. 4 illustrates example data structures for user preference records, location specific content records, and preferred location specific content records.

### DETAILED DESCRIPTION OF EXEMPLARY EMBODIMENTS

### Introduction

The present invention is described to a large extent in this specification in terms of methods for dynamic media interleaving. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system.

Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Definitions

In this specification, the following terms are used as defined here. Other terms are defined elsewhere in the specification and used as defined.

In this specification, the terms “field,” “data element,” and “attribute” are used as synonyms, referring to individual elements of digital data. Aggregates of data elements are referred to as “records” or “data structures.” Aggregates of records are referred to as “files” or “tables.” Aggregates of files are referred to as “databases.” Definitions of complex data structures that include member methods, functions, or software routines in addition to data elements are referred to as “classes.” Instances of complex data structures are referred to as “objects” or “class objects.”

“Browser” means a Web browser, a software application for locating and displaying Web pages. Typical browsers today can display text, graphics, audio and video.

“Coupled for data communications” means any form of data communications, wireless, infrared, radio, internet protocols, HTTP protocols, email protocols, networked, direct connections, dedicated phone lines, dial-ups, serial connections with RS-232 or Universal Serial Buses, hard-wired parallel port connections, and other forms of data communications as will occur to those of skill in the art.

Couplings for data communications wireless modems using analog cellular channels, and communications using CDPD, Cellular Digital Packet Data. Couplings for data communications include wireless access points, wireless network ports according to IEEE standard 802.11, and Bluetooth piconet ports as standardized by the Bluetooth Special Interest Group, and HomeRF ports as standardized by the HomeRF Working Group, as well as infrared ports. Couplings for data communications include Bluetooth piconets implemented in accordance with the well known de facto industry standard known as the “Bluetooth Specification,” a specification for short range radio links among mobile personal computers, mobile phones, and other portable devices.

“LSC” abbreviates “location specific content.”

The term “network” is used in this specification to mean any networked coupling for data communications. Examples of networks useful with the invention include intranets, extranets, internets, local area networks, wide area networks, and other network arrangements as will occur to those of skill in the art. The use of any networked coupling among virtual cameras, electronic photo shops, and devices coupled through designated network addresses is well within the scope of the present invention. In embodiments of the kind illustrated, virtual camera typically includes devices implemented as automated computing machinery, a Web browser, and an internet client having a network address. There is no requirement within the present invention that the internet client have any particular kind of network address.

“Network address” means any network address useful to locate a virtual camera or a designated network address on any network. Network address includes any internet protocol address useful to locate an internet client, a browser, a virtual camera, or a designated network address on the Internet. Network addresses useful with various embodiments of the invention include local internet protocol addresses, private internet protocol addresses, and temporary Internet addresses assigned to a Web client by a DHCP server, and permanent, official registered Internet addresses associated with domain names.

“PLSC” abbreviates “preferred location specific content.” It is usual in patent specification to use the work “preferred” to refer to embodiments. In this specification, however, “preferred” is a quality of location specific content for downloading to client devices.

“Satellite radio” refers to satellite radio sets capable of receiving satellite radio broadcasts or to satellite radio broadcasts of the kind provided by, for example, XM Satellite Radio, Inc., or Sirius Satellite Radio, Inc.

A “store” is one or more storage locations in computer memory. “Storing” is writing data to storage locations in computer memory, typically implemented by a processor operating under stored program control.

“URL” means Uniform Resource Locator, a standard method of associating World Wide Web data locations with network addresses for data communications, are referred to as “URLs.” communications.

“World Wide Web,” or more simply “the Web,” refers to the system of internet protocol (“IP”) servers that support specially formatted documents, documents formatted in a language called “HTML” for HyperText Markup Language. The term “Web” is used in this specification also to refer to any server or connected group or interconnected groups of servers that implement the HyperText Transport Protocol,

“HTTP,” in support of URLs and HTML documents, regardless whether such servers or groups of servers are coupled to the World Wide Web as such.

A “Web site” is a location on the World Wide Web. Web sites are identified by domain names that resolve to Internet addresses. Web sites include storage locations identifiable by URLs. Web sites are implemented in, on, and as part of Web servers, that is, HTTP servers. Web sites are aggregations of computer software installed and operating on computer hardware.

“TDMA” stands for Time Division Multiple Access, a technology for delivering digital wireless service using time-division multiplexing. TDMA works by dividing a radio frequency into time slots and then allocating slots to multiple calls. In this way, a single frequency can support multiple, simultaneous data channels. TDMA is used by GSM.

“GSM” stands for Global System for Mobile Communications, a digital cellular standard. GSM at this time is the de facto standard for wireless digital communications in Europe and Asia.

“CDPD” stands for Cellular Digital Packet Data, a data transmission technology developed for use on cellular phone frequencies. CDPD uses unused cellular channels to transmit data in packets. CDPD supports data transfer rates of up to 19.2 Kbps.

“GPRS” stands for General Packet Radio Service, a standard for wireless data communications which runs at speeds up to 150 Kbps, compared with current GSM systems which cannot support more than about 9.6 Kbps. GPRS, which supports a wide range of speeds, is an efficient use of limited bandwidth and is particularly suited for sending and receiving small bursts of data, such as e-mail and Web browsing, as well as large volumes of data.

“EDGE” stands for Enhanced Data Rates for GSM Evolution, a standard for wireless data communications supporting data transfer rates of more than 300 Kbps. GPRS and EDGE are considered interim steps on the road to UMTS.

“UMTS” stands for Universal Mobile Telecommunication System, a standard for wireless data communications supporting data transfer rates of up to 2 Mpbs. UMTS is also referred to W-CDMA for Wideband Code Division Multiple Access.

“Bluetooth” refers to the Bluetooth Specification, a specification for short range radio links among mobile personal computers, mobile phones, and other portable devices.

“802.11(b)” refers to EEE standard number 802.11(b), a standard of wireless local area network communications.

“HomeRF” refers to the Home Radio Frequency LAN standard promulgated by the HomeRF Working Group. HomeRF is designed to be more affordable for homes, as contrasted with 802.11(b) which was designed for business use.

### DETAILED DESCRIPTION

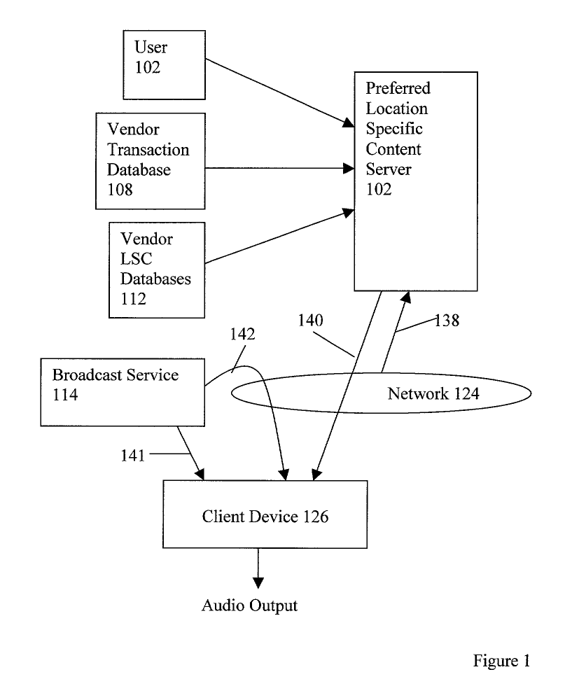

Turning now to FIG. 1, an exemplary embodiment of the invention is illustrated in a system for interleaving preferred location specific content into broadcast content. The illustrated example system includes a preferred location specific content (“PLSC”) server (102) having inputs from users (102), who in typical embodiments are enabled to input directly their programming preferences. The illustrated example system includes input to the PLSC server from vendor transaction databases (108) which themselves are data mined to discover user programming preferences. The illustrated example system of FIG. 1 includes provisions for inputs from vendor location specific content (“LSC”) databases (114), which databases comprise the sources of location specific content in typical embodiments.

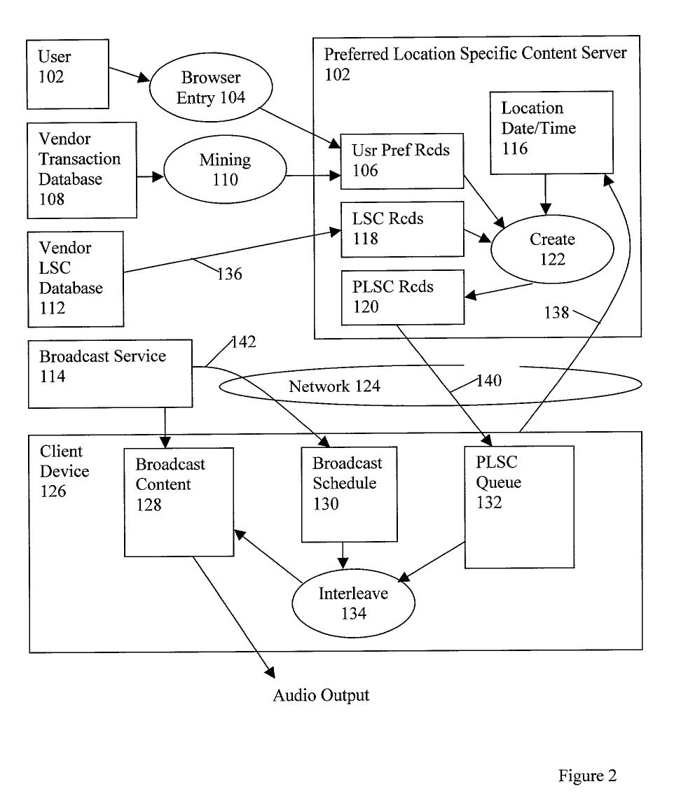

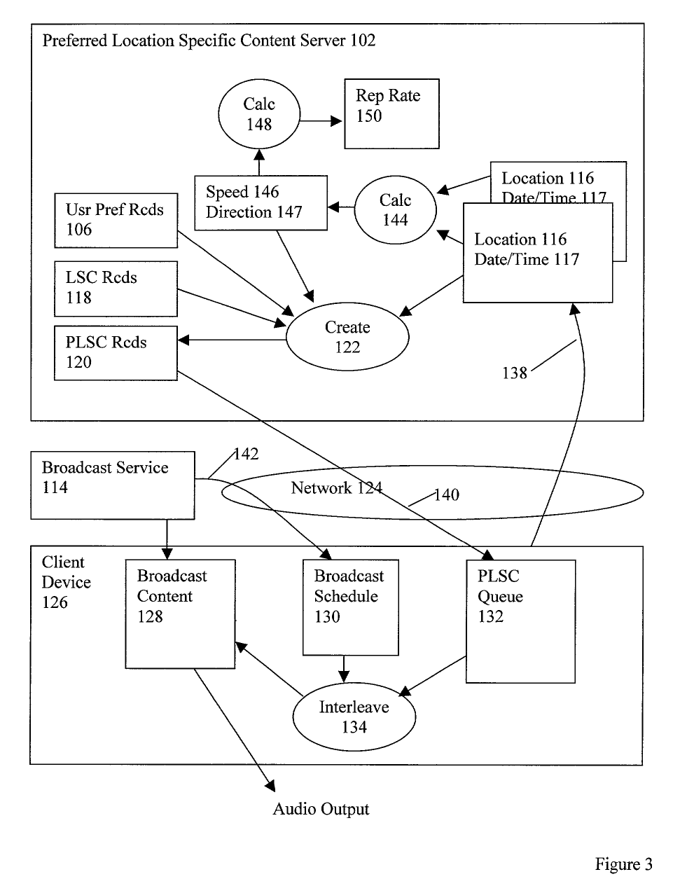

The example system of FIG. 1 includes client devices (126) (one shown), typically FM radios or satellite radios having interleaving capabilities, although other client devices may occur to persons of skill in the art, and the use of any client device capable of accepting broadcast programming and interleaving it with PLSC is well within the scope of the present invention. FIG. 1 also illustrates the provision of a broadcast to a client device (126) from a broadcast service (114) such as, for example, an AM radio broadcast, an FM radio broadcast, or a satellite radio broadcast. Typical exemplary client devices, as shown in more detail in FIGS. 2 and 3, include computer memory for storing broadcast schedules (130), computer memory storage for PLSC (132), and one or more computer processors programmed to interleave (134) PLSC into broadcast program content (128) in dependence upon a broadcast schedule (130).

An example of a large class of embodiments of client devices of the present invention is portable or mobile radio receivers (AM, FM, XM, others, or any combination of these) having integrated cellular telephones implementing backchannels (142, 140) as well as computer processors and computer memory implementing PLSC storage (132), broadcast schedule storage (130), and interleaving (134). The interleaving function also varies across embodiments with the kind of digital content in the PLSC records. To the extent that PLSC records (132) include wav clips, interleaving (134) includes converting wav clips to audio. To the extent that PLSC records (132) include text, interleaving (134) includes text-to-audio conversion.

The broadcast schedule (130) in typical embodiments includes times when interleave slots are available for insertion of PLSC into broadcast program content as well as the duration of such slots. As discussed in more detail below, the downloaded PLSC records (132) typically include an indication of duration for each record of PLSC, and the PLSC records in many embodiments are downloaded in priority order. Interleaving (134) in such embodiments, then, comprises selecting from a PLSC queue (132) the first PLSC record having digital content with a duration equal to or less than the duration indicated in the broadcast schedule for the next interleave slot in the broadcast content.

In typical embodiments, the broadcast schedules (130), the PLSC records, and the location of the client device are communicated through backchannels. “Backchannel” refers to a two way digital coupling for data communications with a client device. Backchannels often support two-way communications. In fact, the term “backchannel” has about it the implication that it is a way for users or client devices to communicate back to content providers. Backchannels typically are not the ‘main channel,’ the channel through which a broadcast service broadcasts broadcast program content to client devices. Backchannels useful with various embodiments of the present invention are implemented through the use of GSM, GPSR, EDGE, UMTS, Bluetooth, HomeRF, or 802.11(b). Other implementations of backchannels will occur to those of skill in the art. The use of any backchannel capable of providing digital communications with client devices is well within the scope of the present invention.

The illustrated example system of FIG. 1 includes backchannel couplings for data communications across a digital communications network (124). The couplings include a backchannel (142) for downloading broadcast schedules from a broadcast service to a client device (126), a backchannel (140) for downloading PLSC from a PLSC server (102) to a client device (126), and a backchannel (138) for uploading to a PLSC server a location (116) of a client device.

In typical embodiments of the present invention, it is a capability of the digital communications network (124) to return to the PLSC server (138) a location of any client device coupled to the PLSC server (102) through the network (124). In fact, for networks providing cellular telephone communications, under the regulations of the Federal Communications Commission in the United States, this capability generally is legally required. Networks having this capability include any digital communications network implemented using GSM, GPSR, EDGE, UMTS, Bluetooth, HomeRF, or 802.11(b). Other network technologies having this capability will occur to those of skill in the art, and the use of all such network technologies is well within the scope of the present invention.

Although FIGS. 1, 2, and 3 show example embodiments in which a backchannel (142) to a broadcast service (114) is used to download broadcast schedules, in alternative embodiments, the broadcast schedules are stored on the PLSC server and downloaded to the client device through the same backchannel (140) used to download PLSC to the client device. In such alternative embodiments (not shown), PLSC servers have couplings for data communications with broadcast services through which are downloaded broadcast schedules for storage on PLSC servers.

Turning now to FIG. 2, exemplary embodiments of the invention are shown as methods of providing preferred location specific content (120, 132) for interleaving (134) into broadcast content (128). Embodiments of such methods typically are implemented upon a content server (102). In exemplary embodiments, the content server typically includes at least one computer processor and computer memory, the processor coupled to the computer memory. In most embodiments, the content server is coupled for data communications through a digital communications network (124) to a user client device (126); the user client device is typically associated in the content server with a particular user; and the particular user is typically represented in the content server by a user account record. In exemplary embodiments, the user account record typically includes data elements comprising a user identification identifying the user, and a network address for the user's user client device within the digital communications network. In such embodiments the user client device is typically associated in the content server with an address in the digital communications network, the digital communications network having the capability of providing the present location (116) of the user client device.

As illustrated in FIG. 2, exemplary embodiments of the invention typically include storing user preferences in user preference records (106), storing location specific content (LSC) in LSC records (118), and receiving (138), from the digital communications network, a location (116) of the user client device. Some embodiments read the local date and time at the location of the client device from the network or from the client device. Other embodiments calculate the local date and time at the location of the client device by using the location of the client device, the location of the PLSC server, and the local time at the location of the PLSC server to make the calculation (not shown).

Further exemplary embodiments include determining local date and time (116) at the location of the user client device, creating (122) preferred location specific content (PLSC) records (120) in dependence upon the LSC records, the user preferences, the location of the user client device, and the local date and time at the location of the client device. More specifically, PLSC records are created in blank, and LSC record to be converted into PLSC records are selected on the basis of user preferences, the location of the user client device, and the local date and time at the location of the client device.

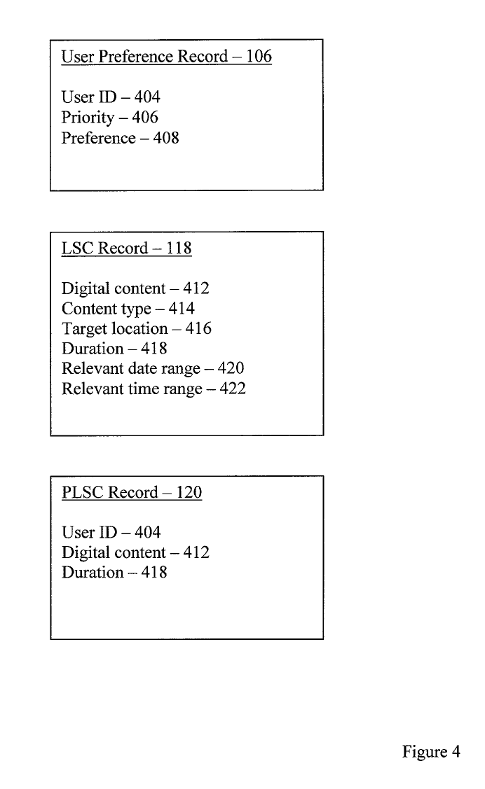

The process of creating PLSC records in completed by copying from the selected LSC records pertinent data fields for inclusion in the PLSC records, including, for example, a user ID so that a client device network address can be found for use at download time, the digital content to be downloaded, interleaved into program content, and played upon a client device, and the duration of the digital content. In embodiments of the kind illustrated in FIG. 4, for example, user preference records (106) include data elements comprising priority (406) and user preferences (408). In some exemplary embodiments LSC records (118) include data elements comprising digital content (412), content type (414), target location (416), duration (418), relevant date range (420), and relevant time range (422). In the example embodiment shown in FIG. 4, exemplary PLSC records (120) include data elements comprising digital content (412), duration (418), and user identification (404).

Typical embodiments include downloading (140) the PLSC records (120) through the digital communications network (140) to the user client device (126). In the example illustrated in FIG. 4, the PLSC record includes a user ID field from which will be inferred, by use of a user account record, for example, a network address for the client device for the download. Other embodiments place the network address directly in the PLSC record along with, or instead of, the user ID.

In exemplary embodiments storing LSC typically includes receiving user preferences entered by a user (102) through a browser (104). The browser is any browser, traditional or advanced, implemented upon a personal computer, or upon a personal digital assistant, a hand-held computer, an internet-enabled cellular telephone handset, or any other device capable of implementing a browser.

In other embodiments, storing LSC records includes data mining (110) LSC from vendors' transaction databases (108). Data mining is technology that discovers or predicts patterns of customer behavior based on historical data. By “vendor” is meant any person, entity, or organization providing LSC for downloading to client devices and interleaving into broadcast program content. In this sense, vendors include police organization, fire departments, highway departments, emergency services, and local public service groups, as well as ordinary commercial suppliers of goods and services. Vendors often have very large quantities of transaction data from which can be inferred preferences of broadcast listeners. (In this specification, broadcast listeners are generally referred to as “users.”) In some embodiments, demographics from user account records in PLSC servers are used by agreement with vendors to enable vendors to effect data mining for preferences meaningful to the users of the client devices accepting downloads of PLSC.

Turning back to FIG. 2, in exemplary embodiments of the invention creating PLSC records typically includes selecting LSC records in dependence upon the user preferences, the location of the user client device, and the local date and time at the location of the client device. In some embodiments creating PLSC records typically includes selecting LSC records having content types, target locations, and relevant date and time ranges that match, for a user, the user preferences from a user preference record for the user, the location of the user client device associated with the user, and the local date and time at the location of the user client device associated with the user.

In exemplary embodiments of the kind illustrated in FIG. 2, downloading the PLSC records to the user client device typically includes downloading the PLSC to the user client device at the network address for the user client device within the digital communications network, wherein the PLSC so downloaded comprises digital content and duration. In some exemplary embodiments the PLSC records to be downloaded include priority, and downloading the PLSC to the user client device includes downloading the PLSC to the user client device in dependence upon priority, and excluding priority from the downloaded PLSC records. In such embodiments, the priority fields are used in effect to sort the download before the download, so that the PLSC records downloaded are received and stored on the client device in priority order, thus eliminating the need for the priority field in the PLSC records actually downloaded. Embodiments of this kind need simpler and therefore cheaper client devices, because the client device need not select PLSC records for interleaving on the basis of priority. The client devices of this kind need only be smart enough to pick the first PLSC record that will fit the next interleave slot, that is, the first PLSC record in the download (which is pre-sorted by priority) whose duration is equal to or shorter than the next available interleave slot identified in the broadcast schedule.

In typical embodiments downloading the PLSC to the user client device includes downloading the PLSC to the user client device at the address with which the user client device is associated in the digital communications network, wherein the PLSC so downloaded includes digital content, duration, and priority. “Priority” in this context includes single-field indications of priority as well as more complex indications of PLSC record type and content. To the extent that such information is available for use in the client device, the client device is made more sophisticated and therefore more expensive in order to utilize it.

Turning now to FIG. 3, a further example embodiment of the invention is shown to comprise storing (138) more than one indication (116) of the location of the user client device (126) and, associated with each such indication of location of the user client device, the local time (117) when the user client device was at the location. The illustrated example includes calculating (144), in dependence upon the stored indications of location and time, a speed (146) of the user client device and a direction of travel (147) of the user client device.

In some exemplary embodiments, creating PLSC records in dependence upon user preferences, the location of the user client device, and the local date and time at the location of the client device includes not only creating (122) PLSC records (120) not only in dependence upon the user preferences (106), the location (116) of the user client device, the local date and time (117) at the location of the client device, but also in dependence upon the speed (146) and direction of travel (147) of the user client device. In typical embodiments of this kind, data indications of user preference (408) include indication of relevant area or a radius around the location of the client device that the user prefers to consider relevant for selection of PLSC. LSC records in such embodiments then are selected for inclusion in PLSC by selecting LSC records having target locations (416) within the area preferred by the user. Embodiments that include speed and direction of travel in addition to present location of a client device typically include calculating a calculated area of relevance, by projecting where the client device will probably be for a relevant period of time, the projection accomplished by use of the speed and direction of the client device. Such embodiments typically include selecting LSC records having target locations within the calculated area of relevance (not shown).

As illustrated in FIG. 3, exemplary embodiments of the invention typically include periodically repeating the steps of receiving a location, determining local date and time, creating PLSC records, and downloading the PLSC records to the user client device. Other embodiments of the invention typically include calculating (148), for the step of periodically repeating, a repetition rate (150), wherein the calculating is carried out in dependence upon the speed (146) of the user client device. By repeatedly creating and downloading fresh PLSC, such embodiments maintain within computer memory stores within the client devices the PLSC which is most relevant to the client device's present location as the client devices move from place to place.

From the detailed description set forth above in this specification, readers can see that embodiments of the invention function, for example, as follows. Assume a user has in the user's automobile a client device, an FM radio having an integrated cell phone and microcomputer storing broadcast schedules and PLSC records, the client device coupled through a backchannel on a GSM network, for example, to a PLSC server. The user registered in the user's preferences on the PLSC server that the user prefers to eat lunch at WhatABurger when one is available at midday, that the user is an avid blues guitar player, and that the user loves to collect antiques. The user's registered preferences include an indication that the user's radius of preferred interest is five miles. WhatABurgers along the user's travel route are vendors having stored LSC records in the PLSC server. As the user drives, for example, from Houston to Austin on Highway 290, coming to Brenham, Tex., at noon, the PLSC server downloads to the client device an advertisement with directions to a WhatABurger in Brenham. As the user nears Austin, the PLSC server downloads to the client device advertisements for Austin blues venues, music shops, guitar stores, and antique shops. As the user nears construction areas on the highway, PLSC warnings are downloaded based on LSC records provided by the Texas State Highway Department. As the user nears the location of a thunderstorm crossing the highway, a severe weather warning in a PLSC record is downloaded based upon an LSC record provided by a local weather service.

It will be understood from the foregoing description that various modifications and changes may be made in the exemplary embodiments of the present invention without departing from its true spirit. The descriptions in this specification are for purposes of illustration only and are not to be construed in a limiting sense. The scope of the present invention is limited only by the language of the following claims.

What is claimed is:

1. A method of providing preferred location specific content for interleaving into broadcast content, the method comprising the steps of:
storing user preferences in user preference records in a content server;
storing location specific content (LSC) in LSC records in the content server;
receiving, from a digital communications network, a location of a user client device;
determining local date and time at the location of the user client device;
creating preferred location specific content (PLSC) records in the content server, the creating carried out in dependence upon the LSC records, the user preferences, the location of the user client device, and the local date and time at the location of the client device; and
downloading the PLSC records through the digital communications network from the content server to the user client device.

2. The method of claim 1 wherein storing LSC further comprises receiving user preferences entered by a user through a browser.

3. The method of claim 1 wherein storing LSC further comprises data mining LSC from vendors' customer databases.

4. The method of claim 1 wherein user preference records comprise data elements comprising priority and user preferences.

5. The method of claim 1 wherein LSC records comprise data elements comprising digital content, content type, target location, duration, relevant date range, and relevant time range.

6. The method of claim 1 wherein PLSC records comprise data elements comprising digital content, duration, and user identification.

7. The method of claim 1 wherein creating PLSC records further comprises selecting LSC records in dependence upon the user preferences, the location of the user client device, and the local date and time at the location of the client device.

8. The method of claim 1 wherein creating PLSC records further comprises selecting LSC records having content types, target locations, and relevant date and time ranges that match, for a user, the user preferences from a user preference record for the user, the location of the user client device associated with the user, and the local date and time at the location of the user client device associated with the user.

9. The method of claim 1 wherein downloading the PLSC records to the user client device further comprises downloading the PLSC to the user client device at the network address for the user client device within the digital communications network, wherein the PLSC so downloaded comprises digital content and duration.

10. The method of claim 9 wherein the PLSC records to be downloaded include priority, and downloading the PLSC to the user client device further comprises:
downloading the PLSC to the user client device in dependence upon priority, and
excluding priority from the downloaded PLSC records.

11. The method of claim 1 wherein downloading the PLSC to the user client device further comprises downloading the PLSC to the user client device at the address with which the user client device is associated in the digital communications network, wherein the PLSC so downloaded comprises digital content, duration, and priority.

12. The method of claim 1 further comprising periodically repeating the steps of receiving a location, determining local date and time, creating PLSC records, and downloading the PLSC records to the user client device.

13. The method of claim 1 comprising the further steps of:
storing more than one indication of the location of the user client device and, associated with each such indication of location of the user client device, the local time when the user client device was at the location; and
calculating, in dependence upon the stored indications of location and time, a speed of the user client device and a direction of travel of the user client device;
wherein creating preferred location specific content (PLSC) records in dependence upon the user preferences, the location of the user client device, and the local date and time at the location of the client device further comprises creating preferred location specific content (PLSC) records in dependence upon the user preferences, the location of the user client device, the local date and time at the location of the client device, and the speed and direction of travel of the user client device.

14. The method of claim 13 comprising the further steps of:
periodically repeating the steps of receiving a location, determining local date and time, creating PLSC records, and downloading the PLSC records to the user client device; and
calculating a repetition rate for the step of periodically repeating, wherein calculating a repetition rate is carried out in dependence upon the speed of the user client device.

15. The method of claim 13 comprising the further steps of:
calculating a calculated area of relevance; and
selecting LSC records having target locations within the calculated area of relevance.

16. The method of claim 15 wherein calculating a calculated area of relevance further comprises projecting where the client device will probably be for a relevant period of time, wherein the projecting is accomplished in dependence upon the speed and direction of the client device.

17. A system for providing preferred location specific content for interleaving into broadcast content, the system implemented upon a content server,
the content server comprising at least one computer processor and computer memory, the processor coupled to the computer memory,
the content server coupled for data communications through a digital communications network to a user client device,
the user client device associated in the content server with a particular user,
the particular user represented in the content server by a user account record,
the user account record comprising data elements comprising:
a user identification identifying the user, and
a network address for the user's user client device within the digital communications network,
the user client device associated in the content server with an address in the digital communications network;
the digital communications network having the capability of providing the present location of the user client device,
the system comprising:
means for storing user preferences in user preference records;
means for storing location specific content (LSC) in LSC records;
means for receiving, from the digital communications network, a location of the user client device;
means for determining local date and time at the location of the user client device;
means for creating preferred location specific content (PLSC) records in dependence upon the LSC records, the user preferences, the location of the user client device, and the local date and time at the location of the client device; and
means for downloading the PLSC records through the digital communications network to the user client device.

18. The system of claim 17 wherein means for storing LSC further comprises means for receiving user preferences entered by a user through a browser.

19. The system of claim 17 wherein means for storing LSC further comprises means for data mining LSC from vendors' customer databases.

20. The system of claim 17 wherein user preference records comprise data elements comprising priority and user preferences.

21. The system of claim 17 wherein LSC records comprise data elements comprising digital content, content type, target location, duration, relevant date range, and relevant time range.

22. The system of claim 17 wherein PLSC records comprise data elements comprising digital content, duration, and user identification.

23. The system of claim 17 wherein means for creating PLSC records further comprises means for selecting LSC records in dependence upon the user preferences, the location of the user client device, and the local date and time at the location of the client device

24. The system of claim 17 wherein means for creating PLSC records further comprises means for selecting LSC records having content types, target locations, and relevant date and time ranges that match, for a user, the user preferences from a user preference record for the user, the location of the user client device associated with the user, and the local date and time at the location of the user client device associated with the user.

25. The system of claim 17 wherein means for downloading the PLSC records to the user client device further comprises means for downloading the PLSC to the user client device at the network address for the user client device within the digital communications network, wherein the PLSC so downloaded comprises digital content and duration.

26. The system of claim 25 wherein the PLSC records to be downloaded include priority, and means for downloading the PLSC to the user client device further comprises:
means for downloading the PLSC to the user client device in dependence upon priority; and
means for excluding priority from the downloaded PLSC records.

27. The system of claim 17 wherein means for downloading the PLSC to the user client device further comprises means for downloading the PLSC to the user client device at the address with which the user client device is associated in the digital communications network, wherein the PLSC so downloaded comprises digital content, duration, and priority.

28. The system of claim 17 further comprising means for periodically repeating the steps of receiving a location, means for determining local date and time, means for creating PLSC records, and means for downloading the PLSC records to the user client device.

29. The system of claim 17 further comprising:
means for storing more than one indication of the location of the user client device and, associated with each such indication of location of the user client device, the local time when the user client device was at the location; and
means for calculating, in dependence upon the stored indications of location and time, a speed of the user client device and a direction of travel of the user client device;
wherein means for creating preferred location specific content (PLSC) records in dependence upon the user preferences, the location of the user client device, and the local date and time at the location of the client device further comprises means for creating preferred location specific content (PLSC) records in dependence upon the user preferences, the location of the user client device, the local date and time at the location of the client device, and the speed and direction of travel of the user client device.

30. The system of claim 29 further comprising:
means for periodically repeating the steps of receiving a location, determining local date and time, creating PLSC records, and downloading the PLSC records to the user client device; and
means for calculating a repetition rate for the step of periodically repeating, wherein means for calculating a repetition rate functions in dependence upon the speed of the user client device.

31. The system of claim 29 further comprising:
means for calculating a calculated area of relevance; and
means for selecting LSC records having target locations within the calculated area of relevance.

32. The system of claim 30 wherein means for calculating a calculated area of relevance further comprises means for projecting where the client device will probably be for a relevant period of time, wherein the means for projecting operates in dependence upon the speed and direction of the client device.

33. A computer program product for providing preferred location specific content for interleaving into broadcast content, the computer program product implemented upon a content server,
the content server comprising at least one computer processor and computer memory, the processor coupled to the computer memory,
the content server coupled for data communications through a digital communications network to a user client device,
the user client device associated in the content server with a particular user,
the particular user represented in the content server by a user account record,
the user account record comprising data elements comprising:
a user identification identifying the user, and
a network address for the user's user client device within the digital communications network,
the user client device associated in the content server with an address in the digital communications network;
the digital communications network having the capability of providing the present location of the user client device,
the computer program product comprising:
a recording medium;
means, recorded on the recording medium, for storing user preferences in user preference records;
means, recorded on the recording medium, for storing location specific content (LSC) in LSC records;
means, recorded on the recording medium, for receiving, from the digital communications network, a location of the user client device;
means, recorded on the recording medium, for determining local date and time at the location of the user client device;
means, recorded on the recording medium, for creating preferred location specific content (PLSC) records in dependence upon the LSC records, the user preferences, the location of the user client device, and the local date and time at the location of the client device; and
means, recorded on the recording medium, for downloading the PLSC records through the digital communications network to the user client device.

34. The computer program product of claim 33 wherein means, recorded on the recording medium, for storing LSC further comprises means, recorded on the recording medium, for receiving user preferences entered by a user through a browser.

35. The computer program product of claim 33 wherein means, recorded on the recording medium, for storing LSC further comprises means, recorded on the recording medium, for data mining LSC from vendors' customer databases.

36. The computer program product of claim 33 wherein user preference records comprise data elements comprising priority and user preferences.

37. The computer program product of claim 33 wherein LSC records comprise data elements comprising digital content, content type, target location, duration, relevant date range, and relevant time range.

38. The computer program product of claim 33 wherein PLSC records comprise data elements comprising digital content, duration, and user identification.

39. The computer program product of claim 33 wherein means, recorded on the recording medium, for creating PLSC records further comprises means, recorded on the recording medium, for selecting LSC records in dependence upon the user preferences, the location of the user client device, and the local date and time at the location of the client device.

40. The computer program product of claim 33 wherein means, recorded on the recording medium, for creating PLSC records further comprises means, recorded on the recording medium, for selecting LSC records having content types, target locations, and relevant date and time ranges that match, for a user, the user preferences from a user preference record for the user, the location of the user client device associated with the user, and the local date and time at the location of the user client device associated with the user.

41. The computer program product of claim 33 wherein means, recorded on the recording medium, for downloading the PLSC records to the user client device further comprises means, recorded on the recording medium, for downloading the PLSC to the user client device at the network address for the user client device within the digital communications network, wherein the PLSC so downloaded comprises digital content and duration.

42. The computer program product of claim 41 wherein the PLSC records to be downloaded include priority, and means, recorded on the recording medium, for downloading the PLSC to the user client device further comprises:
means, recorded on the recording medium, for downloading the PLSC to the user client device in dependence upon priority, and
means, recorded on the recording medium, for excluding priority from the downloaded PLSC records.

43. The computer program product of claim 33 wherein means, recorded on the recording medium, for downloading the PLSC to the user client device further comprises means, recorded on the recording medium, for downloading the PLSC to the user client device at the address with which the user client device is associated in the digital communications network, wherein the PLSC so downloaded comprises digital content, duration, and priority.

44. The computer program product of claim 33 further comprising means, recorded on the recording medium, for periodically repeating the steps of receiving a location, means, recorded on the recording medium, for determining local date and time, means, recorded on the recording medium, for creating PLSC records, and means, recorded on the recording medium, for downloading the PLSC records to the user client device.

45. The computer program product of claim 33 further comprising:
means, recorded on the recording medium, for storing more than one indication of the location of the user client device and, associated with each such indication of location of the user client device, the local time when the user client device was at the location; and
means, recorded on the recording medium, for calculating, in dependence upon the stored indications of location and time, a speed of the user client device and a direction of travel of the user client device;
wherein means, recorded on the recording medium, for creating preferred location specific content (PLSC) records in dependence upon the user preferences, the location of the user client device, and the local date and time at the location of the client device further comprises means, recorded on the recording medium, for creating preferred location specific content (PLSC) records in dependence upon the user preferences, the location of the user client device, the local date and time at the location of the client device, and the speed and direction of travel of the user client device.

46. The system of claim 45 further comprising:
means, recorded on the recording medium, for periodically repeating the steps of receiving a location, determining local date and time, creating PLSC records, and downloading the PLSC records to the user client device; and
means, recorded on the recording medium, for calculating a repetition rate for the step of periodically repeating, wherein means for calculating a repetition rate functions in dependence upon the speed of the user client device.

47. The computer program product of claim 45 further comprising:
means, recorded on the recording medium, for calculating a calculated area of relevance; and
means, recorded on the recording medium, for selecting LSC records having target locations within the calculated area of relevance.

48. The computer program product of claim 47 wherein means for calculating a calculated area of relevance further comprises means, recorded on the recording medium, for projecting where the client device will probably be for a relevant period of time, wherein the means for projecting operates in dependence upon the speed and direction of the client device.
